(19) United States
(12) Patent Application Publication
(10) Pub. No.: US 2019/0117021 A1
(43) Pub. Date: Apr. 25, 2019

(54) MIXING DEVICE FOR STIRRING THE CONTENTS OF DISPOSABLE DRINKING CUPS

(71) Applicant: Scott Amron, Plainview, NY (US)

(72) Inventor: Scott Amron, Plainview, NY (US)

(21) Appl. No.: 15/792,801

(22) Filed: Oct. 25, 2017

(51) Int. Cl. A47J 43/042; A47J 43/046

(52) U.S. Cl. CPC A47J 43/042; B01F 11/0054; A47J 43/046

(57) ABSTRACT

A mixing device is provided with rotating platform and circumferential guide for quickly and effectively stirring the contents of disposable paper and plastic cups of varying sizes without direct contact with the food beverage contents.

### FIELD OF THE INVENTION

This application claims the benefit of the previously filed provisional application No. 62/412,519, titled, “Mixing Device for Stirring the Contents of Disposable Cups” filed on Oct. 25, 2016. The present invention relates to a mixing device with rotating platform and circumferential guide for quickly and effectively stirring the contents of disposable paper and plastic cups of varying sizes without direct contact with the food beverage contents.

### BACKGROUND OF THE INVENTION

### Background

Currently, stir sticks (A.K.A. stirrers) are used to quickly stir milk, cream, sugar, cinnamon, vanilla, nutmeg, whiskey and other ingredients into coffee, tea and other beverages that are commonly distributed in disposable drinking cups. The life cycle of plastic and wooden stir sticks are wasteful from manufacturing and packaging through shipping, storage, dispensing and disposal. A stir stick is typically used for less than 3 seconds before being thrown directly into the trash. Plastic stir sticks are not biodegradable and primarily made from polystyrene, a known carcinogen. Wooden stir sticks contribute to deforestation. It is also unsanitary to dip a stir stick into a beverage if the stir stick dispenser is not cleaned regularly or if the stick was mishandled by one or more users, improperly stored, dropped, or exposed to harmful bacteria prior to use. It is desirable to create a device that can stir the contents of disposable paper and plastic drinking cups of varying sizes without the waste and potential health risks associated with stir sticks. It is also desirable to create a device that can stir without direct contact with the food beverage. The present invention is directed toward overcoming one or more of the problems identified above.

### SUMMARY OF THE INVENTION

The aforementioned deficiencies are addressed, and an advance is made in the art, by a mixing device comprised of a rotating platform and circumferential guide specifically designed to accept a wide range of disposable paper and plastic cup sizes and shapes. The platform rotates at a speed that is fast enough to stir efficiently (greater than 100 RPM), yet slow enough (less than 340 RPM) to calmly stir in a coffee house setting, i.e. mixing stations at Starbucks.

The mixing device is designed specifically for disposable paper and plastic cups to be used at coffee mixing stations located in coffee houses, hotels, offices, breakfast areas, convenience stores, gas station convenience stores, police and fire stations, factory break rooms, etc. . . . It reduces waste resulting from the production, transport and use of stir sticks.

With the present invention, nothing enters the drink. It stirs by rotating counter-clockwise to make use of the overlap 301 construction of disposable paper coffee cups. FIG. 3 shows a top view of a disposable paper drinking cup illustrating the overlap seam 301. The interior of the cup bottom 302 is shown for reference. The device rotates the cup slightly off-center at an optimal speed, while keeping the cup extremely level.

Place your cup onto the platform and it will begin mixing after a brief 0.5 second soft start. It will mix for period of time that is either preset or dependent on the weight of the cup and then soft-stop. It will also stop as soon as the cup is touched for removal.

This mechanism can be integrated into coffee vending machines.

The preferred embodiment is electrically powered, although a manually powered version driven by either a foot pedal or a spring loaded “push-down on cup and release to spin-up” mechanism may be used to drive the platform. It is desirable for the user to be able to operate the device without having to touch the device in an effort to reduce exposure to harmful bacteria and viruses.

A vibrating speaker system such as a bone technology audio transducer can be attached to the platform to further agitate the contents of the drinking cup without direct contact with the food beverage. The platform can be made to vibrate ultrasonically to help vibrate the contents of the cup.

The guide or the platform can be electrostatically charged using a solid state electrostatic generator to electrostatically charge the cup, causing the food beverage contents of the cup to stick to the outer walls of the cup better for a faster more thorough mixing. It does this by causing the outer layer of liquid to stick to the cup's interior walls better. The outer vicious layer then causes the next inner layer to move with the cup and so on inward.

The ice and drinking straw in plastic cups containing iced beverages aid in the stirring process. During my research, I noticed that people with iced coffees would remove the cover of their large plastic cups and stick a much shorter stir stick in it to mix it around a little bit. It is an extremely awkward process that the current invention remedies. All the user needs to do is place their cup with cup lid on atop the platform.

An object of the present invention is to provide a stirring device that can stir the contents of a disposable paper or plastic drinking cup without direct contact with the food beverage.

Another object of the present invention is to provide a stirring device that can easily accept a wide range of varying cup sizes.

Another object of the present invention is to provide a stirring device that can be used on a full cup with or without a cup lid.

A further object of the present invention is to provide a stirring device that reduces waste associated with the production, distribution and disposal of plastic and wooden stir sticks.

A further object of the present invention is to provide a stirring device that the user does not need to touch, thereby reducing risk of illness.

A further object of the present invention is to provide a stirring device that is extremely simple to look at, use and operate.

A further object of the present invention is to provide a device that can easily mix large iced beverages without needing to remove the cup's lid. During my research, I noticed that people with iced coffees would remove the cover of their large plastic cups and stick a much shorter stir stick in it to mix it around a little bit. It is an extremely awkward process especially with the straw and all of the ice in there.

A still further object of the present invention is to provide a device that can be both integrated into a mixing station table and portable enough that it can be placed atop any flat surface. It can be placed on a flat surface or installed flush in any countertop by drilling a 3.25″ hole (using a 3.25″ Hole Saw ($16 at Lowe's)), removing the collar and dropping it into the hole and screwing the collar back on from the bottom to secure it. This is demonstrated in FIG. 7. This hides the drive components and makes the device appear more refined.

### BRIEF DESCRIPTION OF THE DRAWINGS

The various features, functions and advantages characterizing the invention will be better understood by reference to the detailed description which follows, taken in conjunction with the accompanying drawings, in which:

FIG. 1a is a perspective view of a stirring device constructed in accordance with the preferred embodiment of the present invention shown here with a disposable paper drinking cup.

FIG. 1b a perspective view of the same stirring device of FIG. 1a constructed in accordance with the preferred embodiment of the present invention shown here empty without a disposable paper drinking cup.

FIG. 2 is a cross-sectional view of the mixing device of FIG. 1a, illustrating that the platform is driven by a motor housed in a tubular body.

FIG. 3 is a top view of a disposable paper drinking cup illustrating the overlap seam that aids in the stirring effect.

FIG. 4a is a view of a Starbuck's mixing station with two stirring devices constructed in accordance with the preferred embodiment of the present invention integrated into the surface of the countertop.

FIG. 4b is a view of a mixing station surface with a stirring device constructed in accordance with the preferred embodiment of the present invention integrated into a surface next to a trash hole.

FIG. 5a is a schematic of a circuit that can be employed to drive the motor as describe herein.

FIG. 5b is a plan view of the PCB of the schematic of FIG. 5a.

FIG. 6 illustrates linked offset pins to drive a platform in an orbital circular motion around a center point in which case the platform does not rotate in accordance with a secondary embodiment of the present invention.

FIG. 7 illustrates how the collar can be removed (unscrewed) to allow for insertion into a hole located in a countertop.

FIG. 8a is a cross-section of a drinking glass, plastic or metal travel mug or ceramic mug with a fixed raised stir bar shape inside the bottom of the cup to illustrate how a cup design may be modified to stir its contents when rotated.

FIG. 8b is a top view of the cup shown in FIG. 8a.

FIG. 9 is an engineering drawing for the four tab rubber centering part for high speed stirring.

### DETAILED DESCRIPTION OF THE INVENTION

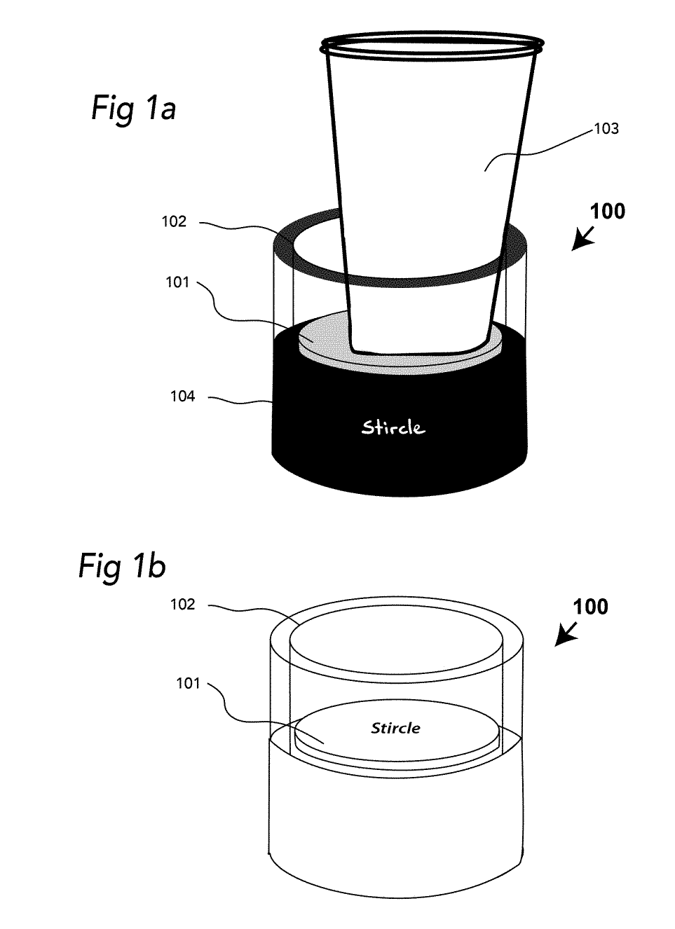

FIG. 1a illustrates a mixing device constructed in accordance with a first preferred embodiment of the present invention, shown generally at 100 with a disposable paper drinking cup 103 placed on the platform 101. The Platform 101 is located within a transparent tube 102 that can be made of polycarbonate, acrylic or glass. The bottom half of the tube 104 is painted opaque to hide the internal components. This causes the top edge of the Tube 102 to darken, thereby aiding to visually guide the user as to where to place their cup 103 within the tube 102.

With reference to FIG. 1a, one can see that the cup 103 sits slightly off center. This improves agitation. For faster stir times with higher speed spinning, a smaller offset is recommended. This can be adjusted by lowering or raising the platform within the circumferential guide. Spinning the cup at higher speeds for a very fast stir time works best when the cup is completely centered. This is recommended for behind the counter industrial mixing activities at coffee houses and fast food restaurants like McDonald's. Lower speeds work best with greater cup placement offset. A compromise can be found, balancing the degree of cup placement offset with spin speed. The user can carelessly place the cup 103 into the tube 102 and achieve this ideal placement without any exacting effort. The inner diameter of the tube 102 is 3″ (a good range for this dimension would be 3″-3.5″). The distance from the surface of the platform 101 to the edge of the tube is 1.75″ (a good range for this dimension would be 1.5″-2.5″). The platform 101 rotates at 200 RPM's (a good range would be 150-400 RPM). FIG. 1b shows the device of FIG. 1a empty without a cup.

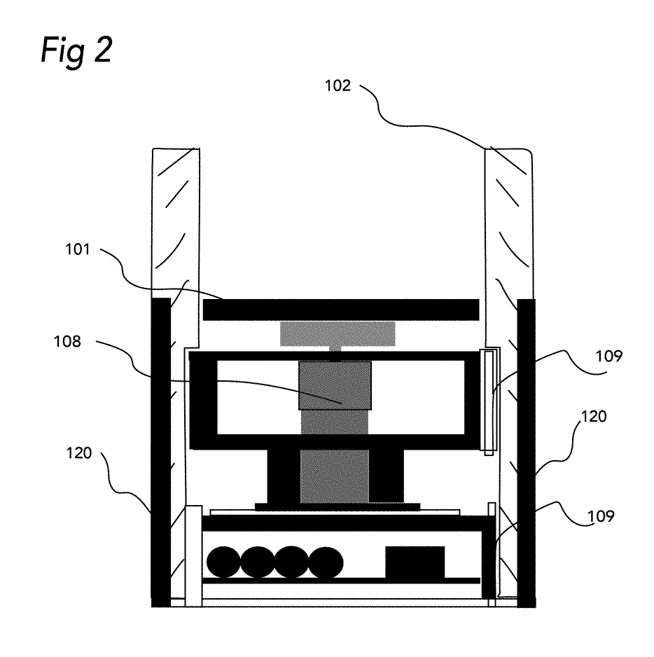

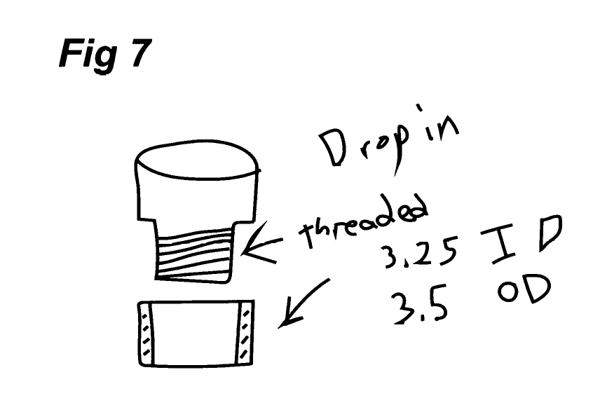

With reference to FIG. 2 the platform 101 is driven by a motor 108. Drain holes 109 aid in preventing flooding. A collar 120 can be removed so that the tube can be installed into the surface of a countertop (mixing station surface)—see FIG. 7.

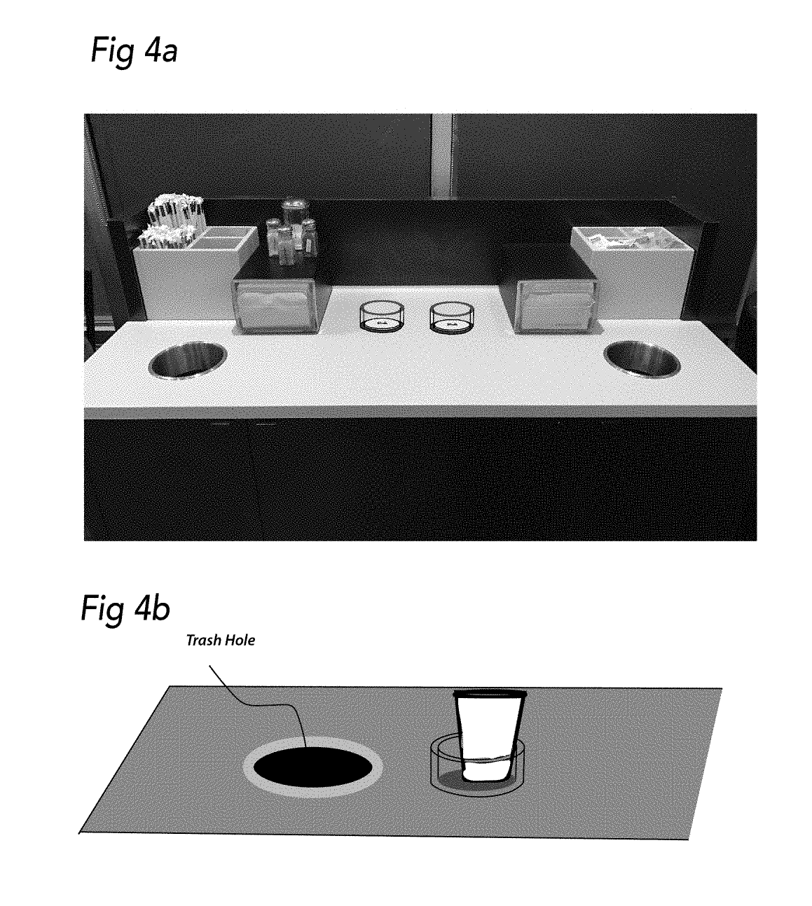

The circular platform 101 is rotated by a geared motor 108 that spins at 170 RPM's such as the GM12a Metal Geared Motor—6 VDC 170 RPM 10.7 oz-in made by Pololu. A circumferential guide 102 aids to easily position cups of varying sizes slightly off center and prevents the cups from be able to tip over should someone knock into it. The surface of the platform 101 should have a low coefficient of friction so that the cup may slide into position easily. The cup should be able to slide relatively easily on the platform. It would not be ideal to make the surface of the platform 101 rubber or rubberized. The device may be integrated into the surface of a mixing table alongside a trash “hole” or napkin dispenser as illustrated in FIG. 4A and FIG. 4B. The device can be powered by an AC wall outlet. It may also be made battery powered to make it portable. The portable device may contain Lithium Ion battery cells that are rechargeable to stir up to 80,000 cups per charge. A low charge indicator light or wireless signal may be transmitted to signal that the device needs to be charged or swapped out for a charged unit.

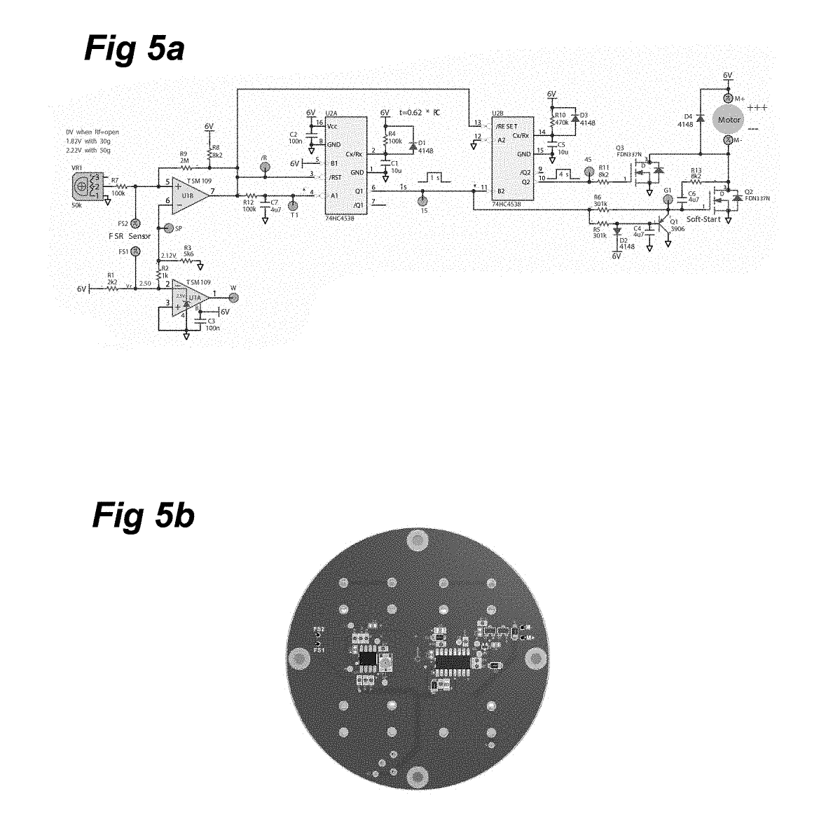

The user places a cup onto the platform 101 within the tubular guide 102. The guide serves to center the cup with a slight off-set. The device includes an electronic circuit shown in FIG. 5a that activates the motor 108 to drive the rotating platform 101 when it senses the presence of a cup 103. This is achieved by weighing the platform 101 with a load sensor or strain gauge or an FSR sensor that detects physical pressure like the Interlink model 406 FSR with a 38 mm square sensing region. If a trigger weight of between 5 grams and 15 grams or more is placed onto the platform 101, the platform 101 will begin to spin with a soft-start for a calming user experience. The platform spins for 4 seconds (a good range for a preset time would be 3-25 seconds) and then stops with a soft-stop for a calming user experience. The user can then remove the cup from the device. The device will not start to rotate again until the weight is removed and then reapplied. In other words, the cup needs to be removed and then put back to start rotating again for the preset time. The weight of the cup can be used to determine the size and shape of the cup and type of beverage it contains to adjust the spin speed and spin sequence timing accordingly. It detects weight to determine which beverage sequence to execute.

For example: A load cell is used to determine the weight of the cup and will select from three spin sequences: one for small (light) cups, One for medium sized (8 oz to 12 oz) and one longer spin sequence for heavier (larger) beverages ranging >12 oz. The “Medium” sequence would be:

Ramp Up clockwise 0 to 250 RPM in 0.4 Seconds

Spin clockwise at 100% or 250 RPM for 0.7 seconds

Spin clockwise at 80% or 200 RPM for 1 second

Ramp Down to 0 RPM in 0.2 Seconds

Ramp Up counter-clockwise 0 to 250 RPM in 0.2 Seconds

Spin counter-clockwise at 100% or 250 RPM for 0.7 seconds

Spin counter-clockwise at 80% or 200 RPM for 1.3 second

Ramp Down to 0 RPM in 0.2 Seconds

Ramp Up clockwise 0 to 250 RPM in 0.2 Seconds

Spin clockwise at 100% or 250 RPM for 0.7 seconds

Spin clockwise at 80% or 200 RPM for 1 second

Ramp Down to 0 RPM in 0.3 Seconds

Making the first spin ramp up slower gives it a feeling of calm. By making the first spin spin for less time than the last two spins, it feels like it takes less time. The middle spin lasts ˜30% longer because at this point the user doesn't feel like it's taking too long.

The device can be made to sense the degree of offset weight or wobble and adjust the speed and sequence accordingly to avoid spilling. It can instantly stop to avoid any spilling or overflow if their is too much wobble. This includes the weight change associated with the user touching or attempting to grab the coffee while it is spinning. If it sense enough of a weight shift or change, it turns off safely. It can't spill. The sensors detect a potential spill scenario and will slow the spin down before any liquid exits the cup. A video camera from above can also be used to detect. It can also be made to detect whether or not the cup has a lid or not by employing a vision system. Adjusting the sequencing, programing and settings, adding thrust spins (moving slightly faster during half the spin and slowing down for the other half), bursts (speeding up quickly to raise the level to get a stir going quickly and then slowing down before the liquid level raises too high), centering methods and cup modifications can all be adjusted to boost efficiency. The centering process can be automated by moving the platform down with an actuator until the cup rests on the collar and weight is removed form the platform. Then raise the platform to lift the cup slightly above the collar so that the weight of the cup rests solely on the platform.

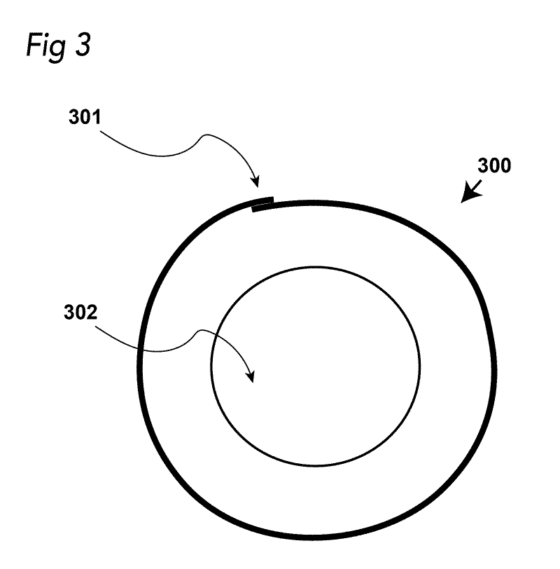

Because the surface of the platform has a low coefficient of friction, the user can remove the cup easily while the platform is spinning. The cup will simply slide briefly and the circuit will stop the platform from spinning instantly as soon as the weigh of the cup is reduced or removed. A soft start and a soft-stop are approximately a 0.5 second ramp up time and a 0.5 second ramp down time respectfully. The circuit is shown in FIG. 5a. The platform rotates counter clockwise. This is to take advantage of the fact that paper cups have a seem 301 on the inside of the cups shown in FIG. 3. When a paper cup is rotated the seem 301 serves to increase the effectiveness of the stirring action. The platform can be programed to toggle and alternate between rotation directions (i.e. Counter clockwise and then Clockwise and then counterclockwise again), as this has shown to greatly improve agitation. The length of time that the platform rotates can be a function of the weight—heavier cups have more to mix so it may be advantageous to spin longer than a lighter cup. If the user goes to remove the cup before the end of the stirring sequence a proximity sensor could be employed detect their hand and stop the spin before they can touch the cup.

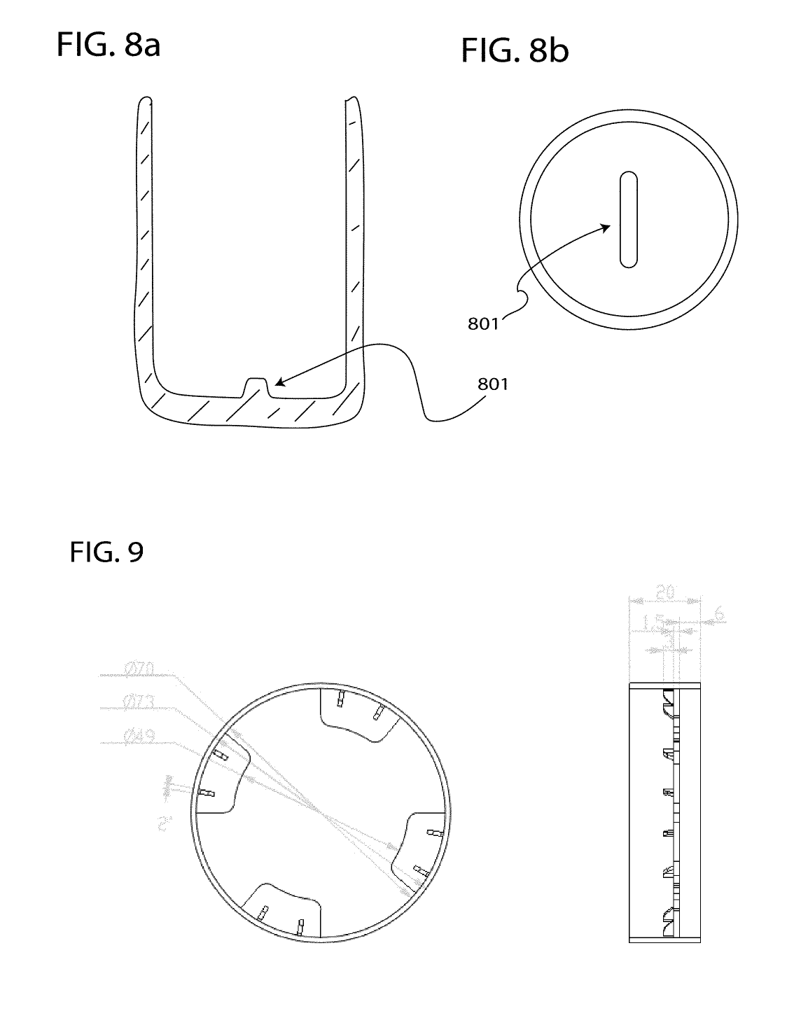

The design of travel mugs and ceramic mugs as well as paper and plastic disposable cups can be modified to mix better by adding a raised detail to the bottom or the sides inside the cup. An example of this would be to integrate the shape of a magnetic stir plate stir bar 801 inside the bottom of a cup as shown in FIG. 8. When the cup spins, the stir bar 801 spins too because it is part of the cup.

For high speed applications where stir time must be kept to an absolute minimum, the cup must be centered. This can be done using a rubber finned collar to center the cup as shown in FIG. 8. The outer ring is rigid ABS plastic. It attaches to the spinning platform. Placing the device on an angle gives the stir a churning effect.

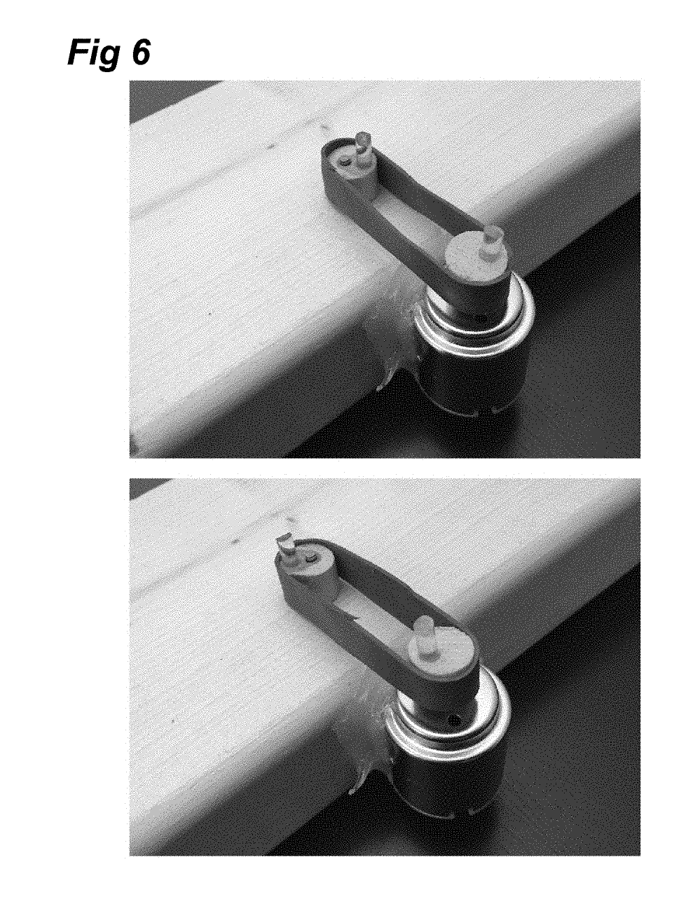

In accordance with a secondary embodiment of the present invention, the platform can also be designed to move in such a way that the cup does not spin or rotate. The platform 101 can be made to move in a circular orbital motion, in which the platform does not rotate. The platform moves in such a way as to orbit a center point without rotating. There are a few ways to do this. One, is by linking two offset posts that fit loosely into two holes located in the bottom of the platform 101, causing the platform to move in a non-rotating circular motion that orbits a center point without spinning as shown in FIG. 6.

1. A mixing device for stirring the contents of disposable cups comprising: a circular rotating platform within a tubular static guide to position cups of varying sizes with a controlled degree of cup placement off-set; wherein said platform is driven by an electric motor.

2. The device of claim 1 wherein said platform is driven by a geared motor at between 160 and 250 RPM.

3. The device of claim 1 wherein the inner diameter of said guide is no less than 3 inches.

4. The device of claim 1 wherein the distance from the surface of the platform to the inner diameter of said guide is 2.25″

5. The device of claim 1 wherein the motor is activated by the weight of the cup.

6. The device of claim 5 wherein the weight of the cup determines the beverage size and type for respective stirring sequence—speed, direction ramp up and down times, etc . . .

7. The device of claim 1 wherein the stirring sequence consists of having the platform spin clockwise, counter-clockwise and then clockwise again OR counter-clockwise, clockwise and then counter-clockwise again.

8. The device of claim 1 wherein the platform includes four or more rubber fins to center the cup for high speed spins.

9. The device of claim 1 wherein the stirring sequence contains a burst to get to speed without too much swell. Then spin at a low speed to maintain the stir. Then reverse.

10. The system wherein a cup or glass, having a fixed integrated raised stir bar shape in the bottom of it's interior, is spun on a spinning platform to mix or stir a liquid or beverage.
